(19) United States
(12) Patent Application Publication
(10) Pub. No.: US 2017/0203995 A1
(43) Pub. Date: Jul. 20, 2017

(54) METHOD FOR PRODUCING A TUBULAR SEMIFINISHED PRODUCT FROM QUARTZ GLASS, METHOD FOR PRODUCING AN OPTICAL COMPONENT USING THE SEMIFINISHED PRODUCT, AND SEMIFINISHED PRODUCT CONSISTING OF QUARTZ GLASS DOPED WITH FLUORINE

(71) Applicant: Heraeus Quarzglas GmbH & Co. KG, Hanau (DE)

(72) Inventors: Gerhard Schoetz, Aschaffenburg (DE); Karsten Braeuer, Bruchkoebel (DE); Andreas Langner, Freigericht (DE)

(21) Appl. No.: 15/473,425

(22) Filed: Mar. 29, 2017

Related U.S. Application Data
(62) Division of application No. 12/998,234, filed on Mar. 29, 2011.

(30) Foreign Application Priority Data
Sep. 29, 2008 (DE) 102008049325.2

(51) Int. Cl. C03B 37/014; C03B 37/027

(52) U.S. Cl. CPC C03B 37/01426; C03B 37/027; C03B 2201/12; C03B 2201/23

(57) ABSTRACT

The aim of the invention is to improve a generally known method for producing quartz glass doped with fluorine, wherein SiO₂ particles are formed in the presence of fluorine by means of a plasma deposition process, deposited in layers on an outer envelope of a cylindrical quartz glass substrate body rotating about its longitudinal axis, and vitrified to form a layer of quartz glass with a fluorine content of at least 1.5 wt. %, in such a way that a quartz glass semifinished product with a high fluorine content, characterised by a high basic transmission in the UV wavelength range, is obtained. To this end, the substrate body has at least one reservoir layer of quartz glass at least in the region of the outer envelope thereof, having a minimum hydroxyl group content of 200 wt. ppm and/or a minimum hydrogen content of 1×10¹⁷ molecules/cm³, and the substrate body is either fully or partially removed following the deposition of the quartz glass layer doped with fluorine.

The present invention relates to a method for producing a tubular semifinished product of quartz glass by forming SiO₂ particles in the presence of fluorine by means of a plasma deposition process and depositing said particles in layers on an outer surface of a cylindrical substrate body of quartz glass rotating about its longitudinal axis, and by vitrifying the particles so as to form a layer of quartz glass with a fluorine content of at least 1.5% by wt.

Furthermore, the present invention relates to a semifinished product of quartz glass comprising a layer of fluorine-doped quartz glass with a fluorine content of at least 1.5 wt. %.

### PRIOR ART

DE 25 364 57 A1 discloses a method for producing a preform, wherein fluorine-doped quartz glass is deposited as cladding glass on a core glass cylinder of undoped quartz glass. To this end an induction-coupled plasma burner is used and fed with starter substances from which fluorine-containing SiO₂ particles are formed in the plasma flame, the particles being deposited in layers on the core glass cylinder rotating about its longitudinal axis and being directly vitrified with formation of the fluorine-containing SiO₂ cladding glass on the core glass cylinder. The plasma outside deposition method for producing fluorine-doped quartz glass is briefly called hereinafter “POD method” (Plasma Outside Deposition).

As a rule, the core glass cylinder is produced by oxidation or by flame hydrolysis of silicon-containing starter substances by means of methods that are generally known under the names VAD (vapor phase axial deposition) method, OVD (outside vapor phase deposition) method, MCVD (modified chemical vapor deposition) method and PCVD or also PECVD (plasma enhanced chemical vapor deposition) method. In the so-called DQ method the deposited SiO₂ particles are directly vitrified on the surface of the substrate body into transparent quartz glass. The core glass cylinder consists most of the time of undoped quartz glass, but it may also contain dopants changing the refractive index.

For producing a tubular semifinished product of quartz glass with a high fluorine content according to the POD method, SiO₂ particles are deposited in the presence of fluorine on the cylindrical outer surface of an elongated substrate body rotating about its longitudinal axis in an atmosphere having a low hydroxyl group content and are vitrified, and the substrate body is subsequently removed fully or in part. Such a method is e.g. known from U.S. Pat. No. 6,253,580 B1. The substrate body is configured as a tube of doped or undoped quartz glass or as a solid rod of graphite, which may additionally be covered with a thin cladding tube of quartz glass. The substrate body material is removed by drilling or etching to obtain a tube of fluorine-doped quartz glass. The fluorine-doped tubular semifinished product is inter alia used as a cladding material for a core glass for producing a preform for optical fibers or as a substrate tube in the MCVD method.

Such fibers are inter alia used for the transmission of high-energy ultraviolet radiation, for instance for spectroscopic, medicinal or photolithographic applications for producing semiconductor components. The corresponding apparatus and machines are often equipped with excimer lasers emitting high-energy pulsed laser radiation of a wavelength of 248 nm (KrF laser) or of 193 nm (ArF laser).

Short-wave UV radiation in the wavelength range between 190 nm and 250 nm can produce defects in the quartz glass of the fiber that lead to increased absorption and are called “photodegradation”. So-called “precursor defect centers” also play an important role. These are initially existing defects in the quartz glass structure that upon UV irradiation cause an immediate increase in absorption, which is referred to as “induced absorption”.

A cladding glass layer consisting of fluorine-doped quartz glass is often produced by means of POD methods directly on a rod made of a prefabricated core glass. Defect centers resulting in a low initial UV transmission and thus a low basic transmission may here be produced in the core glass rod due to the UV radiation of the plasma flame.

To prevent such a situation, DE 103 16 487 A1 makes the suggestion that a plasma flame should be used that exhibits a particularly high radiation intensity at a wavelength of 214 nm. On account of the high UV intensity, defects are rapidly forming in the near-surface area of the core glass rod, which defects exhibit absorption around the wavelength of 214 nm and reduce the further action of energy-rich UV light of the plasma flame. In the final analysis this leads to a reduction of the mean effective damage dose per volume of core glass material particularly in the center of the core glass rod, so that an optical fiber is obtained with a high initial transmission (=basic transmission) in the UV range and of low induced attenuation.

As an alternative procedure, DE 103 16 487 A1 suggests that, instead of a core glass rod, a substrate tube of quartz glass with a wall thickness ranging from 2 mm to 10 mm should be used as the carrier for the POD method, with the tube being removed mechanically (e.g. by grinding, polishing, drilling) or chemically (e.g. by etching off with SF₆) after completion of the deposition process. The resulting tube consists entirely of quartz glass having a fluorine content of at least 3% by wt. After possible further treatment steps it is used for cladding a core glass rod and is elongated together with said rod by means of the rod-in-tube technique into a preform or directly into an optical fiber.

DE 40 34 059 C1 discloses an optical fiber with an irradiation region for the light to be transmitted, which region is conically tapering in irradiation direction. The fiber core consists of undoped synthetic quartz glass having a hydroxyl group content of 650 wt. ppm and a hydrogen content of 10¹⁹ molecules/cm³. The core is surrounded by a jacket of synthetic quartz glass that is doped with 4 wt. ppm fluorine.

### TECHNICAL OBJECT

It is the object of the present invention to provide a semifinished product of quartz glass with a high fluorine content as the cladding glass for optical fibers which are distinguished by a high basic transmission in the UV wavelength range, and to indicate a method for producing such a semifinished product and an optical component produced by using the semifinished product.

As for the method for producing the semifinished product, this object starting from the aforementioned method is achieved according to the invention in that at least in the region of the outer surface the substrate body comprises a reservoir layer of quartz glass having a hydroxyl group content of 200 wt. ppm or more and/or a hydrogen content of 1×10¹⁷ molecules/cm³ or more, and that after deposition of the fluorine-doped quartz glass layer the substrate body is removed either fully or in part.

In the method according to the invention a layer consisting of the fluorine-doped quartz glass is deposited on the surface of a substrate body, the said surface consisting, at least in the near-surface region, of a quartz glass having a relatively high hydroxyl group content and/or of a quartz glass having a relatively high hydrogen content. This near-surface region shall also be called “reservoir layer” hereinafter. The substrate body consists fully or in part of the reservoir layer.

It has been found that in the POD process, possibly due to the UV portion of the plasma flame, precursor defects and thereby induced UV adsorption are produced not only in the core glass, but also in the deposited quartz glass layer. Furthermore, it has been found that the basic transmission of an optical fiber with a core and a fluorine-containing cladding glass layer surrounding the core are surprisingly distinctly influenced by the UV transmission of the cladding glass layer. If the UV basic transmission thereof is low, the basic transmission of the optical fiber is also low.

The following explanations regard a reservoir layer containing hydroxyl groups, hydrogen molecules or both species, which shall also be summarized hereinafter under the term “hydrogen-containing components”.

It has been found that an increased basic transmission of the cladding glass layer can be achieved in the ultraviolet length range if the quartz glass for the cladding glass layer has been deposited on a hydroxyl group-containing quartz glass layer with a hydroxyl group content of at least 200 wt. ppm or if the quartz glass for the cladding glass layer has been deposited on a hydrogen-containing quartz glass layer with a hydrogen content of at least 1×10¹⁷ molecules/cm³.

This effect can be ascribed to the fact that due to high temperatures (in the plasma deposition process) OH groups as well as hydrogen or hydrogen atoms are released from the near-surface areas of the substrate body, and these will then pass into fluorine-doped quartz glass produced by plasma deposition. Hydrogen and hydroxyl groups may there directly prevent defects of the quartz glass structure, which would otherwise be produced by the UV radiation of the plasma process, or may indirectly contribute to the healing of defects.

The defect-healing effect of hydrogen and hydroxyl groups in quartz glass is known. That is why it has e.g. been suggested that quartz glass should subsequently be loaded with hydrogen by treatment under pressure and high temperature, or hydrogen should be provided over-stoichiometrically in the atmosphere in the deposition process. These methods, however, have turned out to be not feasible in the production of fluorine-containing quartz glass by way of a POD method. The provision of hydrogen in the fluorine-containing plasma atmosphere leads to the formation of hydrogen fluoride (HF) and effects an increased etch removal of the quartz glass together with low fluorine doping. And it has also turned out to be not possible to achieve a significant improvement of the basic transmission in a fluorine-doped quartz glass pre-damaged in the POD process by subsequent hydrogen loading.

The method according to the invention chooses another route in that a quartz glass component (substrate body) loaded with hydroxyl groups and/or hydrogen is provided and subjected to high temperature in the POD method, so that during the POD process hydrogen-containing components, such as hydrogen, protons, water or hydroxyl groups, are released that diffuse from there directly into the neighboring, fluorine-doped quartz glass layer. In the invention this permits a transition of the hydrogen-containing components from solid body (substrate body) to solid body (fluorine-doped quartz glass layer) that with respect to the prevention of precursor defects in the fluorine-doped quartz glass leads to better results than an in-diffusion via the gas phase.

In the infrared wavelength range hydroxyl groups show strong absorption bands and are therefore undesired in optical fibers for applications in this wavelength range. As for use in the ultraviolet wavelength range, it is true that hydroxyl groups are normally harmless; nevertheless, in the method according to the invention the fluorine-doped quartz glass is not directly deposited on a hydroxyl group-containing core glass rod so as to avoid damage to the core glass by UV radiation and thereby to ensure a high basic transmission of the optical fiber, but is deposited on a substrate body with hydroxyl group-containing and/or hydrogen-containing reservoir layer.

The reservoir layer is subsequently removed completely, or it remains partly bonded to the fluorine-doped quartz glass layer.

Hence, according to the invention the substrate body is removed either fully or partly after deposition of the fluorine-doped quartz glass layer. A rod or a particularly thick-walled tube can therefore be used as the substrate body, which has an advantageous effect on the mechanical and thermal stability in the deposition process.

In cases where only part of the substrate body is removed, one obtains a quartz glass tube that consists of at least two layers having different quartz glass qualities. Due to its fluorine content the outer quartz-glass layer produced by way of the POD method shows a comparatively low viscosity and it can also be relatively thin. The inner layer originating from the substrate body can thus contribute to a mechanical or thermal stabilization, especially if the inner layer consists of undoped quartz glass or of quartz glass having a lower fluorine content. In this respect the inner quartz-glass layer acts as a support layer in subsequent treatment steps. This has e.g. advantages in the use of the fluorine-doped quartz glass tube for MCVD applications.

A tubular semifinished product produced according to the method of the invention consists fully of fluorine-doped quartz glass, or it comprises a layer of fluorine- doped quartz glass. In comparison with fluorine-doped quartz glass tubes produced according to the standard POD method it shows a significantly higher basic transmission in the wavelength range below 200 nm to 700 nm. This transmission can also not be improved any more in a substantial way in a subsequent hydrogen treatment.

The reservoir layer forms a reservoir for the above-mentioned hydrogen-containing components. The size of the reservoir is substantially determined by the contents of hydrogen-containing components in the layer and further also by the effective volume thereof, from which hydrogen-containing components can be released.

In this respect it has turned out to be advantageous when the reservoir layer has a hydroxyl group content of at least 300 wt. ppm, preferably a hydroxyl group content of at least 500 wt. ppm.

At very high hydroxyl group contents, however, one can observe disadvantages of quartz glass highly loaded with hydroxyl groups, such as a reduction of the viscosity, so that reservoir layers with a hydroxyl group content of more than 1,400 wt. ppm are not preferred.

The hydroxyl group content of the quartz glass of the reservoir layer follows from a measurement of the IR absorption according to the method of D. M. Dodd et al. (“Optical Determinations of OH in Fused Silica” (1966), p. 3911).

Furthermore, it has turned out to be advantageous when the reservoir layer has a hydrogen content of at least 5×10¹⁷ molecules/cm³, preferably a hydrogen content of at least 1×10¹⁸ molecules/cm³.

The more hydrogen molecules are available per volume unit of the reservoir layer, the more pronounced is the effect of the improvement of the basic transmission in the ultraviolet wavelength range. At very high hydrogen contents one can notice disadvantages of highly hydrogen-loaded quartz glass, such as the high efforts in terms of time and energy for producing the hydrogen loading, so that reservoir layers having a hydrogen content of more than 1×10²⁰ molecules/cm³ are not preferred.

The hydrogen content of the quartz glass of the reservoir layer is determined by way of the Raman measurement suggested by Khotimchenko et al. (“Determining the Content of Hydrogen Dissolved in Quartz Glass Using the Methods of Raman Scattering and Mass Spectrometry” in Zhurnal Prikladnoi Spektroskopii, Vol. 46, No. 6 (June 1987), pp. 987-991).

In a particularly preferred variant of the method it is intended that the reservoir layer comprises both a hydroxyl group content of 200 wt. ppm or more and a hydrogen content of 1×10¹⁷ molecules/cm³ or more.

In this instance both the hydroxyl groups and the hydrogen molecules of the reservoir layers serves as a source for the hydrogen-containing components that during the POD method pass into the fluorine-containing quartz glass layer and contribute there to defect healing. The mean concentrations of the respective species (hydroxyl groups, hydrogen) can therefore be chosen to be lower for achieving the same effect.

It has turned out to be useful when the reservoir layer has a thickness of at least 0.5 mm, preferably a thickness of at least 1 mm.

At layer thicknesses of less than 0.5 mm the reservoir for the hydrogen-containing components is rapidly exhausted. At layer thicknesses of more than 5 mm there are long diffusion paths within the substrate body, so that the hydrogen-containing components of the quartz glass in deeper layer regions can be noticed either in a positive or a negative way.

For similar reasons it has also turned out to be advantageous when the layer of fluorine-doped quartz glass produced by plasma deposition has a thickness of less than 10 mm, preferably a thickness of not more than 5 mm.

The improvement of the UV basic transmission of the fluorine-containing quartz glass layer produced by plasma deposition, which improvement is achieved by release (out-diffusion) of hydroxyl groups from the reservoir layer containing the hydrogen-containing component, is decreasing with an increasing thickness of this layer because the diffusion of the hydrogen-containing components is more and more obstructed by the already deposited quartz glass layer.

At layer thicknesses of more than 10 mm, the quartz glass deposited further on the outside remains substantially unaffected by the hydrogen-containing components originating from the reservoir layer. However, the regions of the fluorine-doped quartz glass layer positioned further on the outside also contribute slightly less to the overall attenuation of the optical fiber, so that in applications where a slightly higher basic transmission is acceptable the thickness of the fluorine-doped quartz glass layer produced by plasma deposition can also significantly be more than 10 mm.

With the aim to achieve an effective volume of the reservoir layer that is as high as possible, it has also turned out to be advantageous when the substrate body has an outer diameter of at least 70 mm.

The greater the diameter of the outer surface of the substrate body and thus the free surface thereof, the greater is—at the same layer thickness of the reservoir layer—the effectively available amount of hydrogen-containing components, and thus also the volume of the deposited quartz glass that can benefit from the released hydrogen-containing components.

In a preferred variant of the method it is intended that the substrate body is formed as a tube.

The tubular shape reduces the efforts for the complete or partial removal of the substrate body after the deposition process. Moreover, hydrogen-containing components that can pass via a porous substrate body wall into the deposited quartz glass layer can be fed through the inner bore consecutively (continuously or from time to time). A porous substrate body wall can e.g. be formed as a body of porous SiO₂ soot or a sintered quartz glass frit.

As for the method for producing an optical component, the above-mentioned technical object is achieved according to the invention in that a tubular semifinished product comprising an inner bore and consisting of fluorine-doped quartz glass is produced according to the invention, and a core rod is inserted into the inner bore, and a semifinished product and an inserted core rod are elongated into the optical component.

Hence, the semifinished product produced according to the method of the invention is used as an overcladding tube for cladding a core rod and forms part of the cladding glass of the optical component. As a rule, the core rod consists of core glass enveloped or clad by a cladding glass having a smaller refractive index. The assembly consisting of semifinished product and core rod is either first elongated into a preform, from which a fiber is subsequently drawn, or the assembly is directly elongated into the optical fiber.

After elongation the semifinished product produced according to the method of the invention forms in the optical component a fluorine-containing cladding glass layer which is distinguished by a high UV basic transmission, and has therefore an altogether advantageous effect on the UV transmission of the optical component (preform or fiber).

As for the semifinished product, the above-mentioned object is achieved according to the invention in that the layer of fluorine-doped quartz glass as the outer layer adjoins an inner layer of quartz glass having a hydroxyl group content of at least 200 wt. ppm and/or a hydrogen content of at least 1×10¹⁷ molecules/cm³ and a basic transmission of more than 90% at a wavelength of 250 nm and at a layer thickness of 2 mm.

The tubular semifinished product can be produced by means of the above-described modification of the plasma deposition process according to the invention. It comprises at least one layer of quartz glass that is distinguished on the one hand by a comparatively high mean fluorine content and on the other hand by a comparatively high basic transmission in the ultraviolet wavelength range.

On the one hand, the POD process permits the setting of particularly high fluorine contents in quartz glass (up to about 8% by wt.), which is accompanied by a correspondingly distinct reduction of the refractive index. On the other hand, as found out within the scope of this invention, the standard POD method leads to a lower basic transmission of the fluorine-containing quartz glass in the UV wavelength range. The modification of the POD deposition method according to the invention avoids this drawback, resulting in a semifinished product of a high basic transmission that even in the case of a near-core use in an optical preform does not negatively affect the UV transmission thereof.

Because of its fluorine content, the outer layer produced by the POD method shows a comparatively low viscosity and it can also be relatively thin. In the further processing of the semifinished product the inner layer is beneficial to a mechanical or thermal stabilization, especially when the inner layer consists of undoped quartz glass or of quartz glass having a lower fluorine content, and it acts in this respect as a support layer in subsequent treatment steps. This has e.g. advantages in the use of the fluorine-doped quartz glass tube as a substrate tube for MCVD—in a MCVD method for producing preforms for optical fibers.

The tubular semifinished product according to the invention is also useable as an overcladding tube in preform manufacture according to the so-called rod-in-tube technique as a cladding tube for making so-called PCF fibers (Photonic Crystal Fibers) or as a semifinished product for other manufacturing methods for preforms and optical fibers and for fiber lasers and fiber amplifiers. Optionally, the inner layer can be removed in part or entirely for the further processing of the semifinished product.

Advantageous developments of the semifinished product according to the invention become apparent from the sub-claims. Insofar as developments of the quartz glass tube indicated in the sub-claims copy the procedures mentioned in sub-claims regarding the method according to the invention, reference is made for a supplementary explanation to the above statements on the corresponding method claims.

To be more specific, the tubular semifinished product according to the invention may show extraordinary radial dimensions as are indicated in the sub-claims. These may also ensue on account of the above-explained preferred method variants in the manufacturing process. The radial dimensions of the semifinished product may differ from standard values and are adapted, if necessary, in standard post-treating methods, e.g. elongation, jacketing, coating, or the like, to the standard dimensions if this should turn out to be useful.

### EMBODIMENT

The invention will be explained in detail hereinafter with reference to embodiments and a patent drawing. The drawing is a schematic illustration showing in detail in:

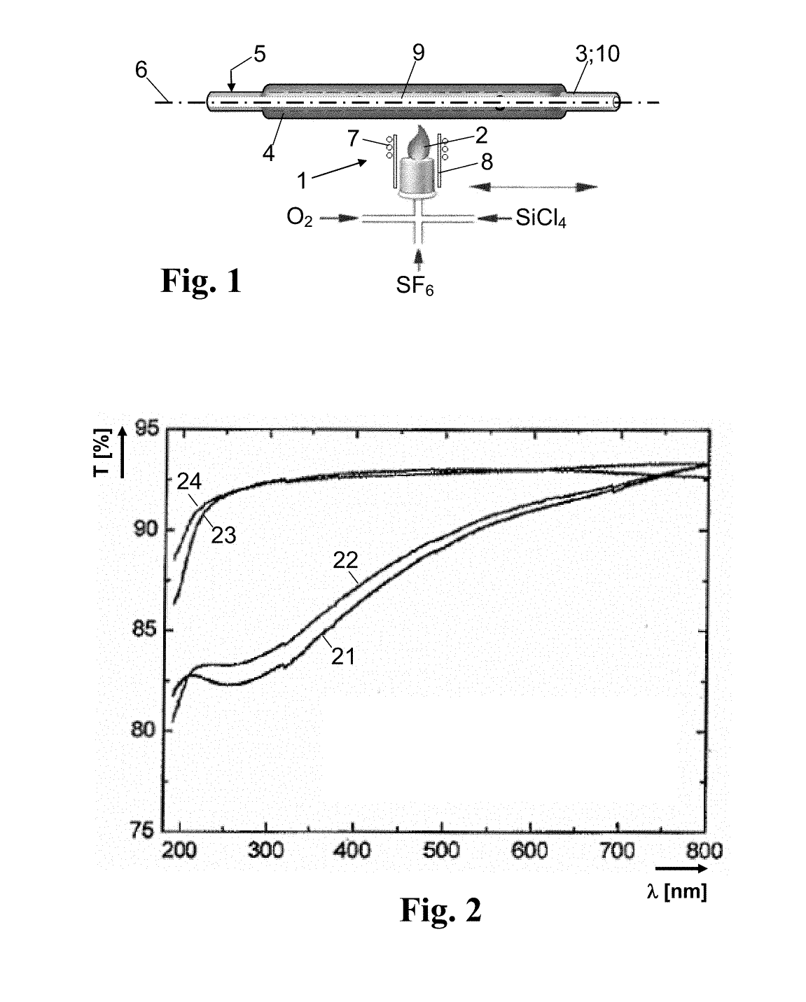

FIG. 1 a device for performing the POD method for depositing fluorine-doped quartz glass; and

FIG. 2 a diagram with transmission curves of different quartz glass qualities in the wavelength range of 190 nm to 800 nm

FIG. 1 schematically shows a device for performing the POD method for depositing fluorine-doped quartz glass on a carrier tube 3.

### EXAMPLE 1

The carrier tube 3 consists of quartz glass doped with hydrogen. The mean hydrogen content is 1×10¹⁸ molecules/cm³. It has an inner diameter of 44 mm and an outer diameter of 54 mm and thus a wall thickness of 5 mm. The carrier tube 3 simultaneously serves as a reservoir layer 10 within the meaning of the invention.

A layer 4 of fluorine-doped quartz glass is produced on the carrier tube 3 (the reservoir layer 10) by means of a POD method. To this end SiCl₄, oxygen and SF₆ are supplied to a plasma burner 1 and converted into SiO₂ particles in a hydrogen-free burner flame 2 assigned to the plasma burner 1. The plasma flame 2 is produced within a reaction sleeve 8 of quartz glass that is surrounded by a high-frequency coil 7.

As the plasma burner 1 is reversingly moved along the carrier tube 3 from one end to the other, the SiO₂ particles are deposited in layers, starting on the cylindrical outer surface 5 of the carrier tube 3 rotating about its longitudinal axis 6. It is thereby possible to incorporate a high fluorine concentration of 5 wt. % with a homogeneous axial and radial distribution in the quartz glass network of the layer 4.

The rotational speed of the carrier tube 3 and the translational speed of the plasma burner 1 are adjusted such that the individual quartz glass layers have a mean thickness of about 12 μm. A layer 4 of fluorine-doped quartz glass with a thickness of 10 mm is thereby produced.

After completion of the deposition process a heated etching-gas stream that contains SF₆ is introduced into the bore 9 of the carrier tube 3. The etching-gas stream is configured such that the carrier tube 3 (the reservoir layer 10) is completely removed and only the glass layer 4 is maintained in tubular form with an inner diameter of 54 mm and a wall thickness of about 10 mm. As an alternative, the carrier tube 3 is removed by machining.

A sample of the fluorine-doped quartz glass tube is subjected to a hydrogen treatment at a temperature of 450° C. for a period of 10 h at a pressure of 5 atm.

Both the quartz glass tube loaded with hydrogen and the quartz glass tube not loaded with hydrogen were subsequently drawn in an elongation process at a draw ratio of 11 (length ratios before and after the elongation process) without any tools into a thin-walled quartz glass tube with an outer diameter of 31 mm and a wall thickness of 2 mm and inflated in this process. To this end an inner pressure raised by 5 mbar in comparison with the outer pressure applied on the outside is maintained in the inner bore.

The quartz glass tube obtained thereby is used as an overcladding tube for producing a preform for optical fibers. A core rod is here inserted into the inner bore and the assembly consisting of quartz glass tube and core rod is elongated into a preform.

### COMPARATIVE EXAMPLE 1 (STANDARD METHOD)

The carrier tube 3 consists of undoped quartz glass with a mean hydrogen content of less than 1×10¹⁶ molecules/cm³ and a low hydroxyl group content of less than 1 wt. ppm. It has an inner diameter of 30 mm and an outer diameter of 40 mm and thus a wall thickness of 5 mm.

A layer 4 of fluorine-doped quartz glass with a thickness of 15 mm is produced on the carrier tube 3 with the help of the POD method of Example 1, and the carrier tube 3 is subsequently removed by introducing a heated SF₆-containing etching-gas stream through the bore 9.

A sample of the fluorine-doped quartz glass tube obtained thereby is loaded with hydrogen, as has been described with reference to Example 1, and the quartz glass tube loaded with hydrogen and also the quartz glass tube not loaded with hydrogen were subsequently elongated and used as an overcladding tube for producing a preform for optical fibers.

FIG. 2 shows transmission curves of the quartz glass tubes produced according to Example 1 (curves 23 and 24) and Comparative Example 1 (curves 21 and 22), (each time prior to the elongation process) in the wavelength range between 190 nm and 800 nm. The basic transmission “T” in % (based on a layer thickness of 2 mm) is plotted on the Y-axis, and the wavelength “X” in nm on the X-axis.

Curve 21 shows the basic transmission of a quartz glass tube produced according to the comparative example (standard OVD method). Particularly in the UV wavelength range between 190 nm and 400 nm, the fluorine-doped quartz glass exhibits a significantly reduced basic transmission which is less than 85% at wavelengths below 250 nm. Owing to the later loading of the quartz glass with hydrogen it was possible to improve the transmission to a certain extent within the whole wavelength range, particularly in the UV range (curve 22), but without being thereby able to raise the basic transmission T at wavelengths below 250 nm to more than 85%.

By contrast, the highly fluorine-doped quartz glass (curve 23) produced in conformity with Example 1 exhibits a much higher basic transmission “T” which is above 90% especially in the UV wavelength range at a wavelength of 250 nm. The transmission curve 24 of the hydrogen-treated sample (Example 1) differs therefrom only slightly. A significant improvement of the basic transmission is thus no longer achievable in the quartz glass of Example 1 by way of hydrogen loading.

### Example 2

A carrier rod which consists of undoped quartz glass having a hydroxyl group content of 700 wt. ppm is used as the substrate body. It has an outer diameter of 60 mm. The carrier rod simultaneously serves as a reservoir layer within the meaning of the invention.

A layer of fluorine-doped quartz glass with a thickness of 10 mm is produced on the carrier rod by means of a POD method, as has been described with reference to Example 1.

After completion of the deposition process the carrier rod is drilled out, with an inner bore being formed having a diameter of 56 mm. This yields a quartz glass tube consisting of an outer layer of a fluorine-doped quartz glass and an inner layer with a thickness of 2 mm of undoped quartz glass, which corresponds to a semifinished product according to the invention. The remaining wall of the original carrier rod with a wall thickness of 2 m is completely removed by passing an SF₆-containing etching-gas stream therethrough.

The quartz glass tube was subsequently drawn in an elongation process at a draw ratio of 12 without any tools into a thin-walled quartz glass tube having an outer diameter of 31 mm and a wall thickness of 2 mm and was inflated in this process. To this end an inner pressure raised by 5 mbar in comparison with the outer pressure applied on the outside was maintained in the inner bore.

The fluorine-doped quartz glass tube obtained thereby is distinguished by a basic transmission in the UV wavelength range that corresponds substantially to that of curve 23 in FIG. 2. It is used as an overcladding tube for producing a preform for optical fibers in that a core rod is inserted into the inner bore, and the assembly consisting of quartz glass tube and core rod is elongated into a preform.

1. A method of producing a tubular semifinished product of quartz glass, said method comprising:
forming SiO₂ particles in the presence of fluorine by a plasma deposition process;
depositing said particles in layers on an outer surface of a cylindrical substrate body of quartz glass rotating about a longitudinal axis;
vitrifying the particles so as to form a layer of quartz glass with a fluorine content of at least 1.5% by wt.,
wherein at least in a region of an outer surface thereof, the substrate body comprises a reservoir layer of quartz glass having at least one of a hydroxyl group content of 200 wt. ppm or more or a hydrogen content of 1×10¹⁷ molecules/cm³ or more, and
wherein, after the deposition of the particles that form the fluorine-containing quartz glass layer, the substrate body is either partly or fully removed.

2. The method according to claim 1, wherein the reservoir layer has a hydroxyl group content of at least 300 wt. ppm.

3. The method according to claim 1, wherein the reservoir layer has a hydrogen content of at least 5×10¹⁷ molecules/cm³.

4. The method according to claim 1, wherein the reservoir layer has both a hydroxyl group content of 200 wt. ppm or more and a hydrogen content of 1×10¹⁷ molecules/cm³ or more.

5. The method according to claim 1, wherein the reservoir layer has a thickness of at least 0.5 mm.

6. The method according to claim 1, wherein the layer of fluorine-containing quartz glass produced by said deposition has a thickness of less than 10 mm.

7. The method according to claim 1, wherein the substrate body has an outer diameter of at least 70 mm.

8. The method according to claim 1, wherein the substrate body is formed as a tube.

9. The method according to claim 1, wherein a fluorine content of at least 4.5% by wt. is set in the fluorine-containing quartz glass layer.

10. A method for producing an optical component, said method comprising:
producing a tubular semifinished product having an inner bore and consisting of fluorine-doped quartz glass, according to claim 1,
inserting a core rod into the inner bore; and
elongating the semifinished product and the inserted core rod so as to form the optical component.

11. (canceled)

12. (canceled)

13. (canceled)

14. (canceled)

15. (canceled)

16. (canceled)

17. The method according to claim 1, wherein the reservoir layer has a hydroxyl group content of at least 500 wt. ppm.

18. The method according to claim 1, wherein the reservoir layer has a hydrogen content of at least 1×10¹⁸ molecules/cm³.

19. The method according to claim 1, wherein the reservoir layer has a thickness of at least 1 mm.

20. The method according to claim 1, wherein the layer of fluorine-containing quartz glass produced by said deposition has a thickness of less than 5 mm.
